(19) United States
(12) Patent Application Publication
(10) Pub. No.: US 2004/0151476 A1
(43) Pub. Date: Aug. 5, 2004

(54) Multichannel reproducing apparatus

(75) Inventor: Shinji Suzuki, Shirakawa-shi (JP)

Correspondence Address: KODA & ANDROLIA, 2029 CENTURY PARK EAST, SUITE 1430, LOS ANGELES, CA, 90067-3024, US

(73) Assignee: Denon, Ltd.

(21) Appl. No.: 10/661,797

(22) Filed: Sep. 12, 2003

(30) Foreign Application Priority Data
Feb. 3, 2003 (JP) 2003-26141

(51) Int. Cl. H04N 5/76; H04N 5/781

(52) U.S. Cl. 386/96; 386/125

(57) ABSTRACT

A multichannel audio reproducing apparatus, in which audio signals of a plurality of channels are processed and the thus processed audio signals are supplied to and reproduced on loudspeakers respectively disposed for each one of the channels, including: a loudspeaker drive section that drives each loudspeaker by imparting a delay time to an audio signal on each channel; a test tone generating section that generates a test tone measuring a distance between loudspeakers and supplying the test tone to one of the loudspeakers; a transmission time measuring section that measures a time period between the generation of the test tone by such one of the loudspeakers and the receiving of the test tone by other loudspeakers, thus obtaining a transmission time between loudspeakers; and a loudspeaker position calculating section that calculates a coordinate position of each loudspeaker based upon the test tone transmission time between loudspeakers.

### BACKGROUND OF THE INVENTION

1. Field of the Invention

The present invention relates to a multichannel reproducing apparatus and more particularly to a multichannel audio reproducing apparatus that reproduces audio signals of a plurality of channels.

2. Prior Art

Multichannel reproducing apparatuses reproduces surround-sound audio signals which give the listener a sense of “being there” feeling. Such a multichannel reproducing apparatus includes a plurality of loudspeakers that typically comprise a front center (Cch) loudspeaker, a front left (Lch) loudspeaker, a front right (Rch) loudspeaker, a rear left surround (SLch) loudspeaker, a rear right surround (SRch) loudspeaker, and a sub-woofer (SWch) loudspeaker; and the audio signals from the various channels are supplied simultaneously to the respective loudspeakers.

When audio signals are supplied to the above-described six loudspeakers by the multichannel reproducing apparatus, if suitable playback separation is imparted to the five loudspeakers other than, for instance, the sub-woofer loudspeaker, sound images will move from one loudspeaker to the next, providing a faithful reproduction of audio signals.

A multichannel audio reproducing apparatus capable of imparting playback separation to the various loudspeakers is described in, for instance, Japanese Patent Application Laid-Open (Kokai) No. H10-243499. In this apparatus, information on positions of the various loudspeakers is inputted beforehand in the reproducing apparatus, so that audio signals having a time delay that corresponds to loudspeaker positions can be supplied to the loudspeakers and more faithful audio signals can be reproduced.

With this reproducing apparatus, however, the user must ascertain the positions of the loudspeakers by measuring, for instance, the distance between the loudspeakers and then input this loudspeaker position information into the reproducing apparatus beforehand. This, however, makes the apparatus more inconvenient to use.

Japanese Patent Application Laid-Open (Kokai) No. 2000-354300 discloses a multichannel audio reproducing apparatus that automatically acquires loudspeaker position information. This reproducing apparatus uses a measurement device that has four microphones disposed at the apexes of a regular tetrahedron and measures the differences in the time it takes audio signals to reach the various microphones, thus obtaining information on the positions of the loudspeakers.

As discussed above, with the apparatus shown in Japanese Patent Application Laid-Open (Kokai) No. H10-243499, the user must ascertain the positions of the loudspeakers by measuring, for instance, the distance between the loudspeakers and then input this loudspeaker position information into the reproducing apparatus beforehand. The apparatus is thus inconvenient to use. The apparatus disclosed in Japanese Patent Application Laid-Open (Kokai) No. 2000-354300 requires, as discussed above, a measurement device that includes four microphones disposed at the apexes of a regular tetrahedron. Accordingly, acquiring information on positions of the loudspeakers entails considerable effort and cost.

### SUMMARY OF INVENTION

Therefore, it is an object of the present invention to provide a multichannel audio reproducing apparatus in which the position information on various loudspeakers can be acquired easily.

The above object is accomplished by a unique structure of the present invention for a multichannel reproducing apparatus in which audio signals from a plurality of channels are processed, and the processed audio signals from the plurality of channels are supplied to and reproduced on loudspeakers respectively disposed for each one of the plurality of channels, and this multichannel reproducing apparatus includes:

a loudspeaker drive section that drives each one of the loudspeakers by imparting a specific delay time to an audio signal on each one of the plurality of channels;

a test tone generating section that generates a test tone used to measure a distance between the loudspeakers and supplying the test tone thus generated to one of the loudspeakers;

a transmission time measuring section that measures a time period taken from a time when the test tone is generated by the above-described one of the loudspeakers until a time when the test tone is received by other loudspeakers, thus obtaining a transmission time between loudspeakers; and

a loudspeaker position calculating section that calculates a coordinate position of each one of the loudspeakers based upon the test tone transmission time between loudspeakers.

### BRIEF DESCRIPTION OF THE DRAWINGS

FIG. 1 illustrates a typical loudspeaker layout in a multichannel audio reproducing system;

FIG. 2 illustrates the multichannel audio reproducing apparatus according to one embodiment of the present invention;

FIG. 3 illustrates the processing of the transmission time measuring section of the multichannel reproducing apparatus of the present invention;

FIG. 4 shows the results of calculating the distance from one loudspeaker;

FIG. 5 shows the results of calculating the distances between various loudspeakers;

FIG. 6 illustrates the position information on each loudspeaker;

FIG. 7 illustrates the manner of inputting the listening position; and

FIG. 8 illustrates the distances between the listening position and the various loudspeakers.

### DETAILED DESCRIPTION OF THE INVENTION

Embodiments of the present invention will now be described with reference to the accompanying drawings.

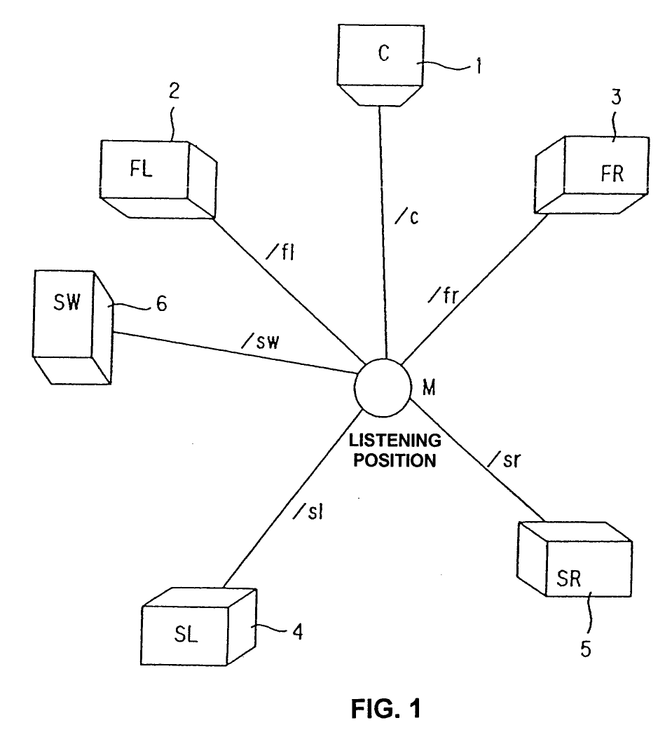

FIG. 1 illustrates a typical loudspeaker set-up layout when a multichannel reproducing apparatus is used for multichannel audio reproducing.

In FIG. 1, the reference numeral 1 is a front center (Cch) loudspeaker, 2 is a front left (FLch) loudspeaker, 3 is a front right (FRch) loudspeaker, 4 is a rear left surround (SLch) loudspeaker, 5 is a rear right surround (SRch) loudspeaker, and 6 is a sub-woofer (SWch) loudspeaker. The distances of the above-described loudspeakers from the listening position M are respectively indicated by reference symbols /c, /fl, /fr, /sl, /sr, and /sw.

As long as the distances /c, /fl, /fr, /sl, /sr, and /sw from the listening position M to each loudspeaker are all the same, there will be no difference in the time it takes the audio signals from the various loudspeakers to reach the listening position M. However, if there is a difference in the distances from the loudspeakers to the listening position M, the time it takes for the audio signals to reach the listening position will differ by an amount of time that corresponds to the distance divided by the speed of sound (the speed of sound is approximately 340 m/s).

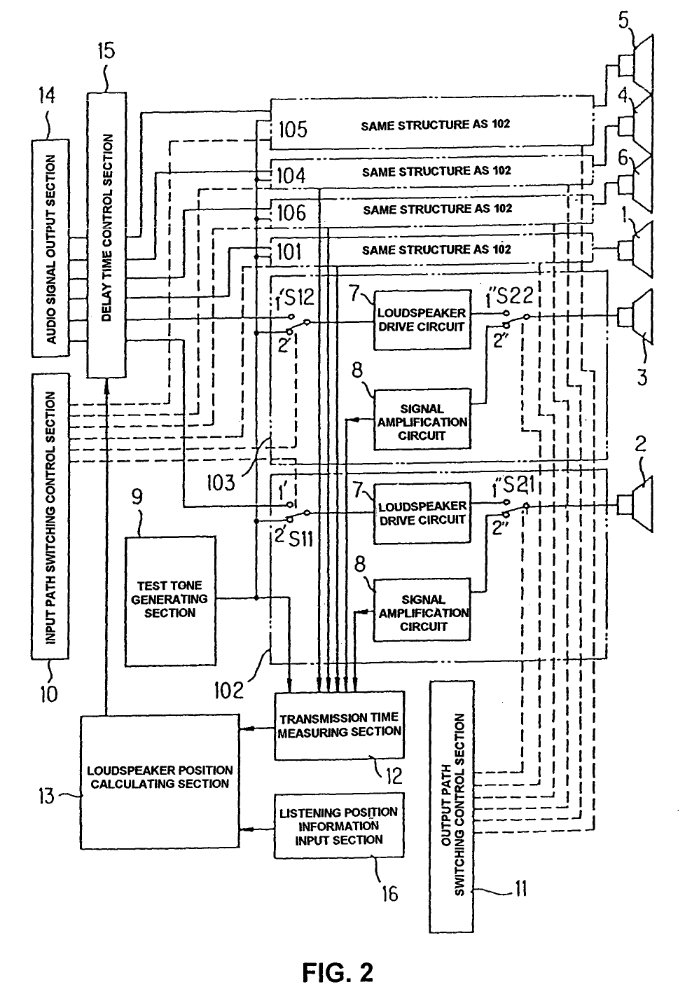

FIG. 2 illustrates the multichannel reproducing apparatus of the shown embodiment.

In FIG. 2, the reference numeral 101 is a front center (Cch) loudspeaker drive section, 102 is a front left (FLch) loudspeaker drive section, 103 is a front right (FRch) loudspeaker drive section, 104 is a rear left surround (SLch) loudspeaker drive section, 105 is a rear right surround (SRch) loudspeaker drive section, and 106 is a sub-woofer (SWch) loudspeaker drive section. The loudspeaker drive sections 101, 102, 103, 104, 105, and 106 are each equipped with a loudspeaker drive circuit 7 for driving the loudspeaker connected to the respective driver and a signal amplification circuit 8 for amplifying the received signals when the loudspeakers receive a test tone (discussed below).

The reference numeral 9 is a test tone generating section that generates test tone signals (such as pulse signals). The reference numerals S11, S12, . . . S1n are switches disposed on the input side of each one of the loudspeaker drive sections. Each switch selects, via terminals 1′ and 2′, a corresponding channel signal among the multichannel signals generated by a delay time control section 15 or a test tone generated by the test tone generating section 9 and then supplies the selected channel signal or test tone to the loudspeaker drive circuit 7. The reference numerals S21, S22, . . . S2n are switches disposed on the output side of each one of the loudspeaker drive sections. Each switch selectively forms, via terminals 1″ and 2″, either a circuit that sends an output of the loudspeaker drive circuit 7 to the corresponding loudspeaker or a circuit that supplies a test tone signal reception output received by that loudspeaker to the signal amplification circuit 8.

The reference numeral 10 is an input path switching control section that switches the switches S11, S12, . . . S1n to the test tone generating section 9 side when the transmission time is measured by a transmission time measuring section 12. The reference numeral 11 is an output path switching control section that switches the switches S21, S22, . . . S2n to the signal amplification circuit 8 side when the transmission time is measured.

The above-described transmission time measuring section 12 measures a transmission time (delay time) from the generation of a test tone done by the test tone generating section 9 until the test tone is received by the signal amplification circuits 8. The reference numeral 16 is a listening position information input section used by the listener to input listening position information to the multichannel reproducing apparatus. The reference numeral 13 is a loudspeaker position calculating section that calculates the distance (or the transmission time) between the listening position and each loudspeaker based upon the measured transmission time and listening position information. The reference numeral 14 is an audio signal output section that outputs audio signals processed by the multichannel reproducing apparatus. The delay time control section 15 referred to in the above imparts a specific delay (discussed below) for each channel to the audio signals of the various channels outputted from the audio signal output section 14.

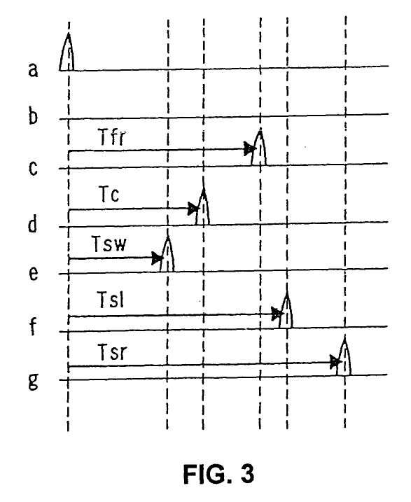

FIG. 3 illustrates the processing by the transmission time measuring section 12.

In FIG. 3, the reference symbol a represents the test tone waveform generated by the test tone generating section 9, b the test tone reception waveform from the front left (FLch) loudspeaker 2, c the test tone reception waveform from the front right (FRch) loudspeaker 3, d the test tone reception waveform from the front center (Cch) loudspeaker 1, e the test tone reception waveform from the sub-woofer (SWch) loudspeaker 6, f the test tone reception waveform from the rear left surround (SLch) loudspeaker 4, and g the test tone reception waveform from the rear right surround (SRch) loudspeaker 5. Since the front left (FLch) loudspeaker 2 generates the test tone in the shown embodiment, there is no test tone reception waveform from this front left (FLch) loudspeaker 2. Also, the transmission times measured by the transmission time measuring section 12 are labeled with the reference symbols Tfr, Tc, Tsw, Tsl, and Tsr in FIG. 3.

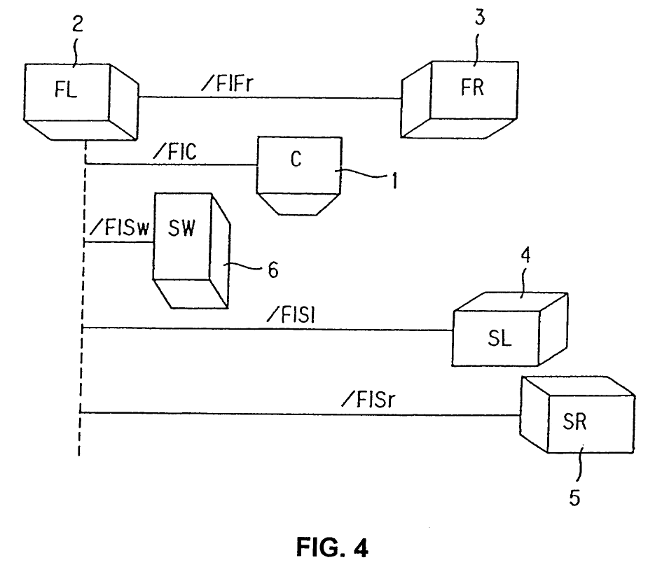

FIG. 4 shows the results of calculating the distances between the front left (FLch) loudspeaker 2 and each one of the loudspeakers 3, 1, 6, 4, and 5 based upon the transmission times Tfr, Tc, Tsw, Tsl, and Tsr and the speed of sound. In FIG. 4, the calculated distances are labeled with the reference symbols /FlFr, /FlC, /FlSw, /FlSl, and /FlSr, respectively. However, position information on the loudspeakers 1, 2, 3, 4, 5, and 6 is not obtained with these calculation results shown in FIG. 4.

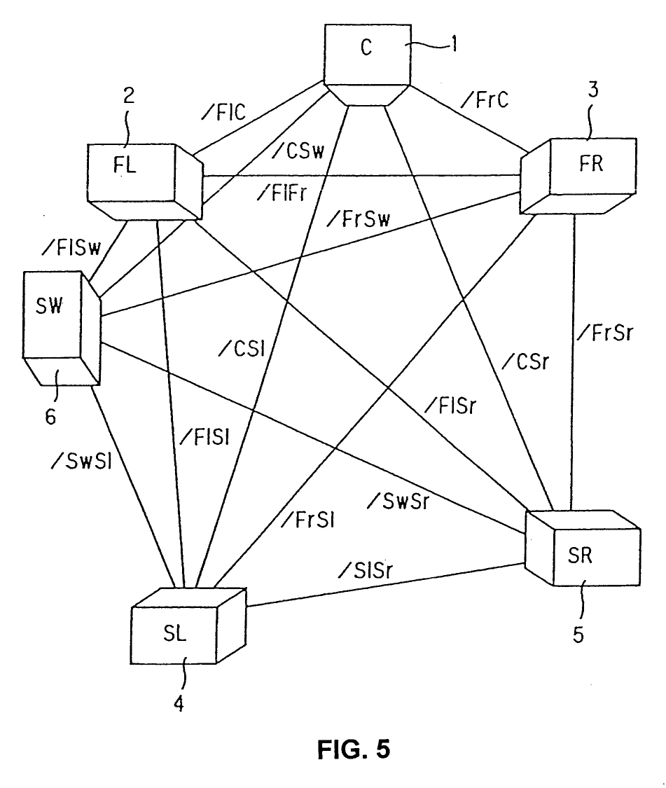

FIG. 5 shows the results of calculating the distances from each one of the loudspeakers 3, 1, 6, 4, and 5 to each one of other loudspeakers, just as in the case described above in which a test tone is generated from the front left (FLch) loudspeaker 2 and the distances from the front left (FLch) loudspeaker 2 to each one of the loudspeakers 3, 1, 6, 4, and 5 are calculated. These distances among the loudspeakers 3, 1, 6, 4, and 5 are referred to in substantially the same manner as in FIG. 4 by reference symbols, for instance, FrC with a “/”. In this case, the value, which is obtained when a test tone is generated from, for example, the front left (FLch) loudspeaker 2 and the distance to the front right (FRch) loudspeaker 3 is calculated, is the same as a value obtained when a test tone is generated from the front right (FRch) loudspeaker 3 and the distance to the front left (FLch) loudspeaker 2 is calculated. Accordingly, the calculation of one of these distances can be omitted. Variance can be suppressed by way of averaging iterated values, for instance.

The distances between the loudspeakers, 1, 2, 3, 4, 5, and 6 are determined by the processing described above; and as a result, the position information (coordinate position) for each loudspeaker is found based upon the thus determined distances between respective three points.

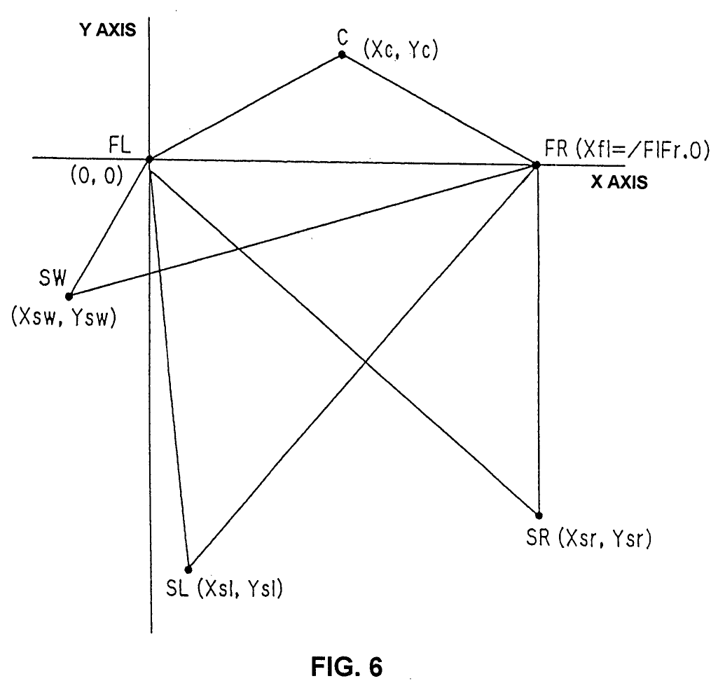

FIG. 6 illustrates the position information on the various loudspeakers found as described above. In the example of FIG. 6, the position of the front left (FLch) loudspeaker 2 is used as the origin (0,0), and the front right (FRch) loudspeaker 3 is disposed on the X axis.

In this example, the description is made on the loudspeakers being laid out on a same plane (two-dimensionally). However, if there are height differences in the installation of the loudspeakers, then the position information (three-dimensional coordinate position) for each loudspeaker can be ascertained based upon the distances determined above between four points.

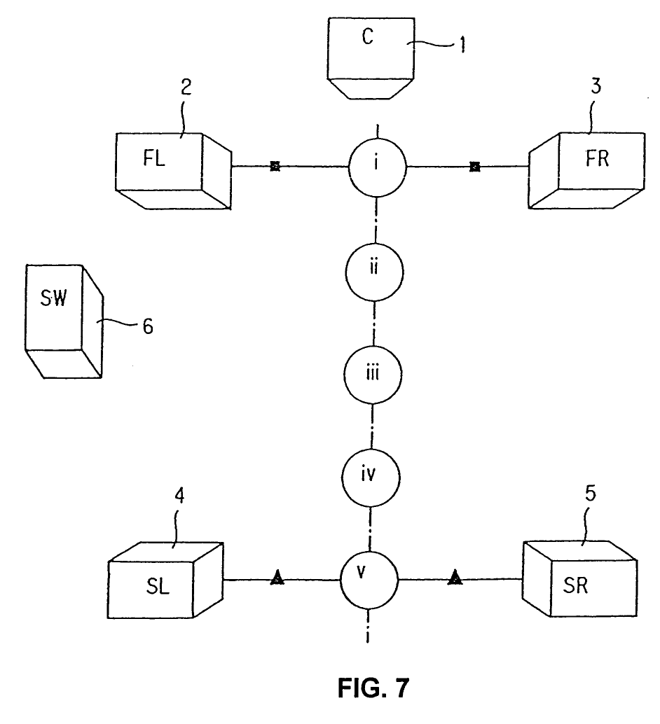

FIG. 7 illustrates the manner of inputting the listening position.

As shown in FIG. 7, a line connecting the center point between the front left (FLch) loudspeaker 2 and the front right (FRch) loudspeaker 3 and the center point between the rear left surround (SLch) loudspeaker 4 and the rear right surround (SRch) loudspeaker 5 is divided into, for instance, four equal parts, and these division points (i, ii, iii, iv, and v) are selected and inputted as the listening position M.

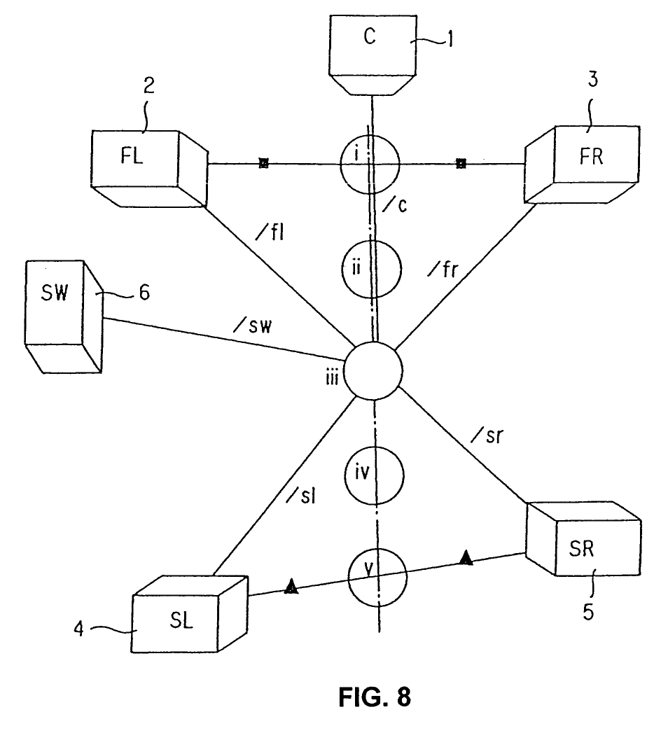

FIG. 8 illustrates the distances (/c, /fl, /fr, /sl, /sr, and /sw) between the listening position and the loudspeakers 1, 2, 3, 4, 5, and 6, calculated by the loudspeaker position calculating section 13 based upon the position information (three-dimensional coordinate position) determined for each loudspeaker and the selected listening position (iii).

The audio signal supplied to the loudspeaker having the longest distance out of the above-described distances (/c, /fl, /fr, /sl, /sr, and /sw) calculated by the loudspeaker position calculating section 13 is set by the delay time control section 15 as a reference (delay time 0), and a delay time that corresponds to the difference from that distance is imparted by the delay time control section 15 to the audio signals supplied to the other loudspeakers.

For instance, if the longest of the distances (/c, /fl, /fr, /sl, /sr, and /sw) is the distance /fr between the listening position (iii) and the front right (FRch) loudspeaker 3, then the delay times imparted to the audio signal supplied to the loudspeakers are as follows:

Delay time for loudspeaker 2: (/fr-/fl)/340

Delay time for loudspeaker 3: used as reference; thus delay being 0 (zero)

Delay time for loudspeaker 1: (/fr-/c)/340

Delay time for loudspeaker 6: (/fr-/sw)/340

Delay time for loudspeaker 4: (/fr-/sl)/340

Delay time for loudspeaker 5: (/fr-/sr)/340

Once the delay times to be imparted to the audio signals supplied to the various loudspeakers have been set by the above procedure, the input path switching control section 10 switches the switches S11, S12, . . . S1n to the delay time control section 15 side. Furthermore, the output path switching control section 11 switches the switches S21, S22, . . . S2n to the loudspeaker drive circuit 7 side. This allows the audio signals for each of the channels to reach the listening position without a time difference. In other words, the audio signals are heard simultaneously.

As seen from the above, with the shown embodiment, positional information on the various loudspeakers can be obtained easily and automatically. Also, audio signals can be reproduced without any offset in how they are heard by using the obtained positional information on the loudspeakers.

Also, in the shown embodiment, it is possible to input the listening position after the loudspeaker position information has been determined. Accordingly, even if the listening position is changed every time the listener uses the system, the specific delay time can be quickly imparted to the audio signals. Also, positional information on loudspeakers can be calculated based upon the transmission time (delay time) from the generation of a test tone until this test tone is received. In other words, the position information on each loudspeaker can be obtained quickly regardless of the distances between the loudspeakers.

As described in detail above, according to the multichannel reproducing apparatus of the present invention, positional information on each one of loudspeakers can be obtained easily.

1. A multichannel reproducing apparatus in which audio signals from a plurality of channels are processed, and processed audio signals of said plurality of channels are supplied to and reproduced on loudspeakers respectively disposed for each one of said plurality of channels, said multichannel reproducing apparatus comprising:
a loudspeaker drive section for driving each one of loudspeakers by imparting a specific delay time to an audio signal on each one of said plurality of channels;
a test tone generating section for generating a test tone used to measure a distance between said loudspeakers and supplying said test tone thus generated to one of said loudspeakers;
a transmission time measuring section for measuring a time period taken from a time when said test tone is generated by said one of said loudspeakers until a time when said test tone is received by other loudspeakers, thus obtaining a transmission time between loudspeakers; and
a loudspeaker position calculating section for calculating a coordinate position of each one of said loudspeakers based upon said transmission time between loudspeakers.

2. A multichannel reproducing apparatus in which audio signals from a plurality of channels are processed, and processed audio signals of said plurality of channels are supplied to and reproduced on loudspeakers respectively disposed for each one of said plurality of channels, said multichannel reproducing apparatus comprising:
a loudspeaker drive section for driving each one of loudspeakers by imparting a specific delay time to an audio signal on each one of said plurality of channels;
a test tone generating section for generating a test tone used to measure a distance between said loudspeakers and supplying said test tone thus generated to one of said loudspeakers;
a transmission time measuring section for measuring a time period taken from a time when said test tone is generated by said one of said loudspeakers until a time when said test tone is received by other loudspeakers, thus obtaining a transmission time between loudspeakers;
a loudspeaker position calculating section for calculating a coordinate position of each one of said loudspeakers based upon said transmission time between loudspeakers; and
a listening position input section for inputting a listening position in relation to a coordinate position calculated by said loudspeaker position calculating section.

3. A multichannel reproducing apparatus in which audio signals from a plurality of channels are processed, and processed audio signals of said plurality of channels are supplied to and reproduced on loudspeakers respectively disposed for each one of said plurality of channels, said multichannel reproducing apparatus comprising:
a loudspeaker drive section for driving each one of speakers by imparting a specific delay time to an audio signal on each one of said plurality of channels;
a test tone generating section for generating a test tone used to measure a distance between said loudspeakers and supplying said test tone thus generated to one of said loudspeakers;
a transmission time measuring section for measuring a time period taken from a time when said test tone is generated by said one of said loudspeakers until a time when said test tone is received by other loudspeakers, thus obtaining a transmission time between loudspeakers;
a loudspeaker position calculating section for calculating a coordinate position of each one of said loudspeakers based upon said transmission time between loudspeakers; and
a listening position input section for inputting a listening position in relation to a coordinate position calculated by said loudspeaker position calculating section,
wherein said loudspeaker position calculating section calculates a transmission time or a distance between said listening position and each one of said loudspeakers based upon said listening position.

4. The multichannel reproducing apparatus according to claim 3, a delay time imparted to said loudspeaker drive section is calculated based upon said transmission time or distance which is between said listening position and each loudspeaker and calculated by said loudspeaker position calculating section.
